(19) United States
(12) Patent Application Publication
(10) Pub. No.: US 2011/0038304 A1
(43) Pub. Date: Feb. 17, 2011

(54) Telecommunication network broadband off-loading system and method

(76) Inventors: Yi-Neng Lin, Hsinchu City (TW); Wendell Lee, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,395

(22) Filed: Aug. 11, 2009

(51) Int. Cl. H04W 40/00

(52) U.S. Cl. 370/328

(57) ABSTRACT

A telecommunication network broadband off-loading system and method, wherein, a first multi-service-packet-control unit and a second first multi-service-packet-control unit are provided in offsetting and off-loading packets onto one or a plurality of xDSLs or fiber glass cables through a load balance mechanism to proceed with packet transmission, and in this way of packet offsetting and off-loading transmission, a stable quality of service can be maintained. Through application of said telecommunication network broadband off-loading system and method disclosed, the load of transmission equipment and transmission cost can be significantly reduced, hereby raising transmission efficacy and performance.

### BACKGROUND OF THE INVENTION

1. Field of the Invention

The present invention relates to a telecommunication network broadband off-loading system and method, and in particular to a telecommunication network broadband off-loading system and method applicable to a third generation (3G) Universal Mobile Telecommunications System (UMTS) and a 3.9 generation (3.9G) System Architecture Evolution (SAE).

2. The Prior Arts

Along with the rapid progress and development of the technology of communications, the improvement of the capability of getting on network and the advancement of access technology of mobile communication devices have led to the overload of the signal transmission facilities to a very series extent. In recent years, due to the ever increasing popularity and utilization of the third generation (3G) Universal Mobile Telecommunications System (UMTS), the speed of user terminal getting on line has increased by a factor of thousands. However, in the face of such a rapid and explosive growth, the improvement of signal transmission technology has been restricted to a very limited advancement in hardware. In addition, for the 3.9G System Architecture Evolution (SAE) in gradual formation, the packets sent out by a base station are transmitted to a Core Network through an S1 protocol interface. However, to the predictable increase of getting-on-line speed, the S1 protocol interface bandwidth will be insufficient for certain. Therefore, in the present situation, it is an urgent and important task to find out an appropriate means of reducing transmission cost and bandwidth requirement within the specifications of the existing system framework and transmission protocol, while keeping and ensuring the packet transmission quality. By way of example, as disclosed in Taiwan Patent Case No. 1243620, in a third generation (3G) Universal Mobile Telecommunications System (UMTS) system, a RAN IP gateway is provided to serve as an interface for connecting a Time Division Duplex-Radio Local Area Network (TDD-RLAN) to a public Internet, and it will supplement or be incorporated into a Serving General Packet Radio Service (GPRS) Support Node (SGSN) or a Gateway GPRS Support Node (GGSN) in a UMTS system in support of packet exchange. However, the adoption of RAN IP gateway for supporting packet transmission does not provide adequate means in solving the problem of insufficient transmission bandwidth. Therefore, the efficacy of this approach is not quite satisfactory. In view of the shortcomings and drawbacks of the existing system, the present invention discloses a telecommunication network broadband off-loading system and method, combining a transmission off-loading mechanism with a balance mechanism in order to achieve better system performance.

### SUMMARY OF THE INVENTION

A major objective of the present invention is to provide a telecommunication network broadband off-loading system and method, wherein, a first multi-service-packet-control unit (MSPCU) and a second multi-service-packet-control unit (MSPCU) are utilized to off-load packets onto an off-loading link, so as to offset the flux of a packet transmission flow and relieve the problem of insufficient bandwidth, hereby raising the transmission efficacy and performance.

Another objective of the present invention is to provide a telecommunication network broadband off-loading system and method, that is used to balance the flux of a packet transmission flow, and reduce the load of transmission equipment, thus achieving stable Quality of Service (QOS).

A yet another objective of the present invention is to provide a telecommunication network broadband off-loading system and method, that is used to reduce the response latency of request, such as HTTP request, and is capable of detecting and filtering out the transmission of packets containing viruses.

In order to achieve the above-mentioned objective, the present invention provides a telecommunication network broadband off-loading system and method. Wherein, at least a base station in a Universal Mobile Telecommunications System (UMTS) is used to send out packets (at least a packet); a radio network controller is used to receive and recombine the packets; a portion of the packets are offset and off-loaded onto an off-loading link through a first multi-service-packet-control unit, and are transmitted to an Internet/Intranet through the off-loading link; the packets transmitted to the Internet/Intranet are transmitted to a destination server through a non-convergent route, or, alternatively, the packets are transmitted to a second multi-service-packet-control unit via a convergent route, and then the packets are converged to a Servicing GPRS Support Node (SGSN) via the second multi-service-packet-control unit in proceeding with packet transmission and exchange. In another embodiment of the present invention, in a System Architecture Evolution (SAE), at least a base station is used to send out packets (at least a packet); these packets are received through a first multi-service-packet-control unit, and then they are off-loaded onto an off-loading link, and subsequently are transmitted to an Internet/Intranet via the off-loading link; and the packets thus transmitted to the Internet/Intranet are then transmitted to a destination server through a non-convergent route, or alternatively, the packets are transmitted to a second multi-service-packet-control unit via a convergent route, then through the second multi-service-packet-control unit, the packets transmitted to the Internet/Intranet are converged to a Serving Gateway (S-GW) to perform packet transmission and exchange.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of a framework of a telecommunication network broadband off-loading system according to a first embodiment of the present invention;

FIG. 2 is a schematic diagram of a framework of a telecommunication network broadband off-loading system according to a second embodiment of the present invention;

FIG. 3 is a schematic diagram illustrating a packet off-loading route for the first multi-service-packet-control unit and the second multi-service-packet-control unit according to the present invention;

FIG. 4 is a schematic diagram of a format of a control-plane packet according to an embodiment of the present invention;

FIG. 5 is a schematic diagram of a format of a user-plane packet according to an embodiment of the present invention

FIG. 6 is a schematic diagram of convergent route transmission in realizing Quality of Service in an application-based way; and

FIG. 7 is a schematic diagram of convergent route transmission in realizing Quality of Service in a GTP-U Tunnel-Based way.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

The present invention discloses a telecommunication network broadband off-loading system and method, wherein, the flux of the transmitted packet flow can be reduced or off-loaded by means of an off-loading link and through the disposition and arrangement of a first multi-service-packet-control unit and a second multi-service-packet-control unit, as such reducing the load of transmission equipment and achieving cost reduction, while maintaining stable quality of transmission. In the following, the preferred embodiments of the present invention are described in explaining in detail the technical characteristics of the present invention.

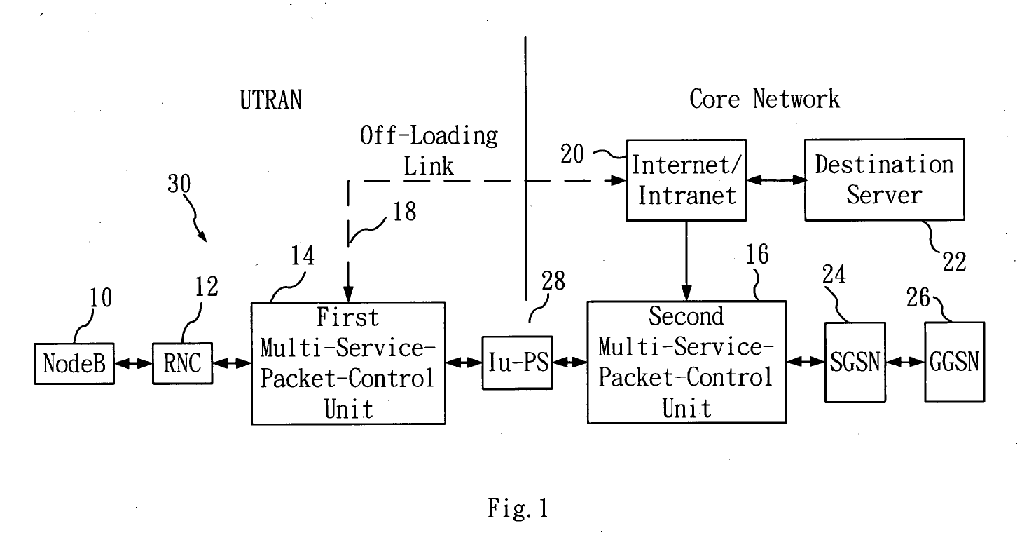

Refer to FIG. 1 for a schematic diagram of a framework of a telecommunication network broadband off-loading system according to a first embodiment of the present invention. As shown in FIG. 1, at least a base station (Node B) 10 is provided, and that is utilized to send out packets (at least a packet) (not shown). The packets are transmitted to at least a radio network controller 12 connected to the base station (Node B) 10. The radio network controller 12 is used to receive and recombine the packets sent from the base station (Node B) 10, and transmit the recombined packets to a first multi-service-packet-control unit 14 connected thereto; a portion of the packets thus transmitted are offset and off-loaded onto an off-loading link 18 via the first multi-service-packet-control unit 14, and are subsequently transmitted to an Internet/Intranet 20 through the off-loading link 18; and then the packets thus transmitted are converged and received by a second multi-service-packet-control unit 16 connected to the Internet/Intranet 20, and are converged to a Serving GPRS Support Node (SGSN) 24 through the second multi-service-packet-control unit 16, and then proceeding with packets exchange and transmission through the Serving GPRS Support Node (SGSN) 24 and a Gateway GPRS Support Node (GGSN) 26.

Moreover, a destination server 22 is connected to the Internet/Intranet 20, such that the packets transmitted to the Internet/Intranet 20 via the off-loading link 18 can be transmitted directly from the Internet/Intranet 20 to the destination server 22, and which will respond to the first multi-service-packet-control unit 14 upon receiving the packets. In addition, a packet-switching-interface-protocol interface (Iu-PS) 28 is disposed between the first multi-service-packet-control unit 14 and the second multi-service-packet-control unit 16. The first multi-service-packet-control unit 14 and the second multi-service-packet-control unit 16 are connected together through utilizing the packet-switching-interface-protocol interface 28 to proceed with packet transmission. The first multi-service-packet-control unit 14 and the second multi-service-packet-control unit 16 can both be independent units, or they can be integrated into the radio network controller 12 and the Serving GPRS Support Node (SGSN) 24 separately. The first multi-service-packet-control unit 14 and the second multi-service-packet-control unit 16 can be made into a caching mechanism, a filtering mechanism and a compression mechanism, so as to reduce the bandwidth utilized and shorten the response latency of a server, and also perform packet compression and packet virus detection, thus raising the transmission efficiency of packets.

As mentioned above, in a first embodiment of the present invention, a first multi-service-packet-control unit 14 and a second multi-service-packet-control unit 16 are provided in a UMTS 30, for the purpose of supporting packets off-load. Wherein, an off-loading link 18 and a packet-switching-interface-protocol interface 28 are utilized to perform packet off-load and transmission between: a UMTS Terrestrial Radio Access Network (UTRAN) composed of a base station (Node B) 10, a radio network controller 12, and a first multi-service-packet-control unit 14; and a Core Network composed of an Internet/Intranet 20, a destination server 22, a second multi-service-packet-control unit 16, a Serving GPRS Support Node (SGSN) 24, and a Gateway GPRS Support Node (GGSN) 26.

In addition, in the present invention, the System Architecture Evolution (SAE) may also utilize the first multi-service-packet-control unit 14 and the second multi-service-packet-control unit 16 in supporting the off-loading of packets.

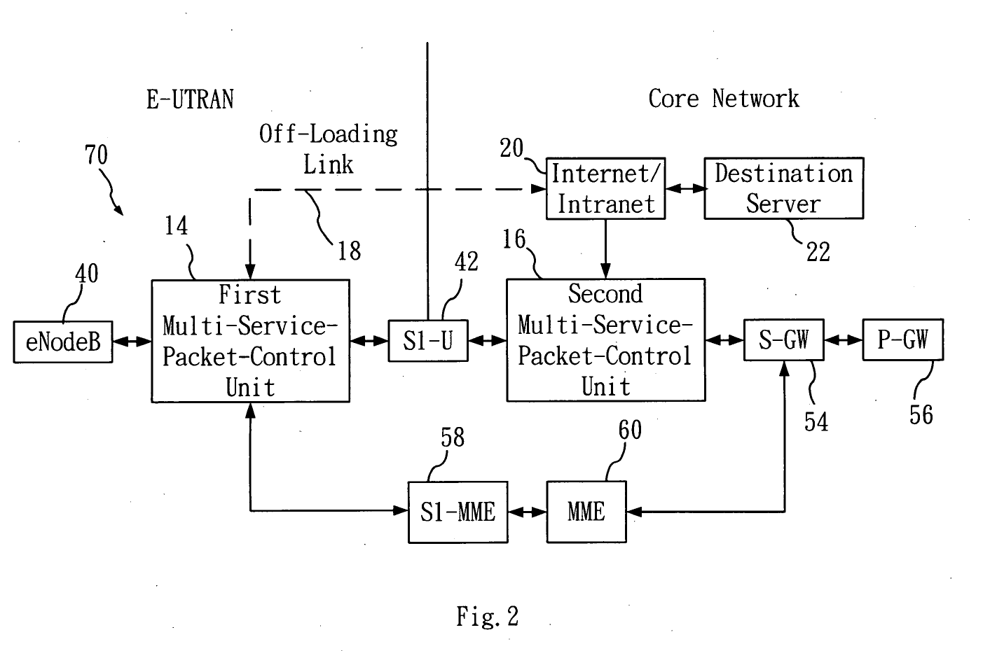

Refer to FIG. 2 for a schematic diagram of a framework of a telecommunication network broadband off-loading system according to a second embodiment of the present invention. As shown in FIG. 2, a System Architecture Evolution (SAE) 70 includes an Evolved UMTS Terrestrial Radio Access Network (E-UTRAN) and a Core Network. Wherein, the Evolved UMTS Terrestrial Radio Access Network (E-UTRAN) includes at least a base station (eNode B) 40, and a first multi-service-packet-control unit 14; and the Core Network includes an Internet/Intranet 20, a second multi-service-packet-control unit 16, a destination server 22, a Serving Gateway (S-GW) 54, a Packet Data Network Gateway (P-GW) 56, and a Mobility Management Entity (MME) 60. In this framework, a base station (eNode B) 40 sends out packets (at least a packet) (not shown), that are received and recombined by the first multi-service-packet-control unit 14, then the packets are off-loaded onto an off-loading link 18, subsequently, they are transmitted to an Internet/Intranet 20 via the off-loading link 18; then the packets transmitted to the Internet/Intranet 20 are converged and received by the second multi-service-packet-control unit 16, and then are converged to a Serving Gateway (S-GW) 54; finally, packet exchange and transmission are performed between the Serving Gateway (S-GW) 54 and the Packet Data Network Gateway (P-GW) 56.

Moreover, a destination server 22 is connected to the Internet/Intranet 20, such that the packets transmitted to the Internet/Intranet 20 via the off-loading link 18 can be transmitted directly from the Internet/Intranet 20 to the destination server 22, and which will respond to the first multi-service-packet-control unit 14 upon receiving the packets.

In addition, the first multi-service-packet-control unit 14 is connected to the Mobility Management Entity (MME) 60 through a control plane (S1-MME) 58, and the Mobility Management Entity (MME) 60 is connected to the Serving Gateway (S-GW) 54, hereby enabling packet exchange and transmission in between. A user plane (S1-U) 42 is provided between the first multi-service-packet-control unit 14 and the second multi-service-packet-control unit 16, such that the first multi-service-packet-control unit 14 and the second multi-service-packet-control unit 16 can be connected to each other via the user plane (S1-U) 42 in proceeding with packet transmission. The first multi-service-packet-control unit 14 and the second multi-service-packet-control unit 16 can be independent units, or they can be integrated into a base station (eNode B) 40 and the Serving Gateway (S-GW) 54 separately and be provided with a caching mechanism, a filtering mechanism and a compression mechanism, so as to reduce the bandwidth utilized and shorten the response latency of a server, and also perform packet compression and packet virus detection, thus raising the transmission efficiency of packets.

In the description mentioned above, the system frameworks of the Universal Mobile Telecommunications System (UMTS) 30 of the first embodiment and of the System Architecture Evolution (SAE) 70 of the second embodiment are described in detail. In the frameworks of these two systems, the packet transmissions between various units contained therein are of a double direction transmission mode. In the following, an off-loading method in the two systems are described in more detail, that is realized through utilizing the first multi-service-packet-control unit 14 and the second multi-service-packet-control unit 16.

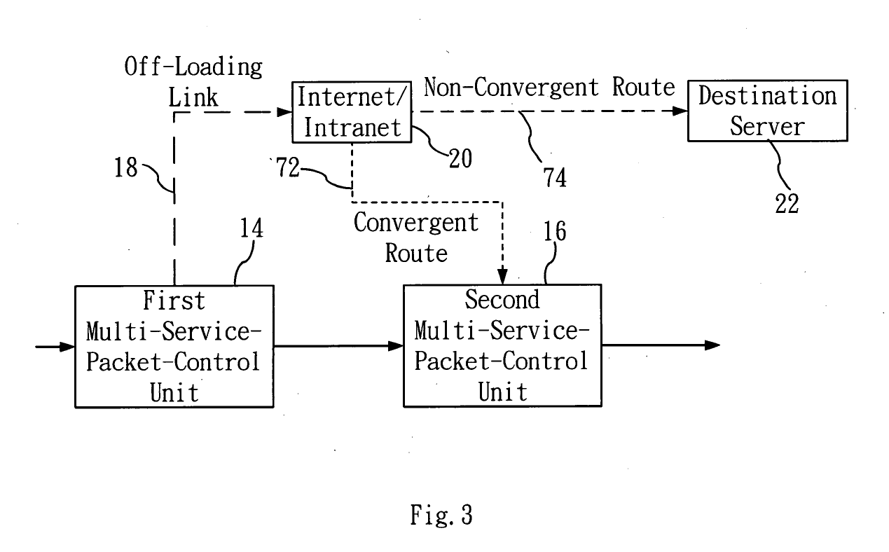

Refer to FIG. 3 for a schematic diagram illustrating a packet off-loading route for the first multi-service-packet-control unit and the second multi-service-packet-control unit according to the present invention; meanwhile refer to FIG. 1 for a schematic diagram of a framework of a telecommunication network broadband off-loading system according to a first embodiment of the present invention. As shown in FIGS. 1 & 3, when a base station (Node B) 10 sends out packets to a radio network controller 12, the packets will be transmitted to the first multi-service-packet-control unit 14 via the Radio Network Controller 12, then the first multi-service-packet-control unit 14 will off-load the packets onto an Internet/Intranet 20, and then the packets off-loaded to the Internet/Intranet 20 will be converged to a second multi-service-packet-control unit 16 via a convergent route 72, and the packets will then be transmitted to a Serving GPRS Support Node (SGSN) 24 from the second multi-service-packet-control unit 16, and then the Serving GPRS Support Node (SGSN) 24 will proceed with packet exchange with a Gateway GPRS Support Node (GGSN) 26; or, alternatively, the packets off-loaded to the Internet/Intranet 20 can be transmitted directly to a destination server 22 via a non-convergent route 74. Wherein, the convergent route 72 is a Virtual Private Network Tunnel, and for its upper layer transmission protocol, a reliable Transmission Control Protocol (TCP) is utilized. Therefore, the packets transmitted via the convergent route 72 can be assured of the security and integrity of package transmission. In addition, the packets transmitted through the non-convergent route 74 will first undergo network address conversion as performed by the first multi-service-packet-control unit 14, namely, for a recombined packet, the source Internet Protocol (IP) address will be converted into an Internet Protocol (IP) address of the first multi-service-packet-control unit 14, such that upon receiving a packet transmitted via the non-convergent route 74, the destination server 22 is aware of the address of the first multi-service-packet-control unit 14, thus being able to proceed with the subsequent responses.

In the description mentioned above, the packet off-loading method of the Universal Mobile Telecommunications System (UMTS) 30 of the first embodiment is explained in detail, while the basic principle of the packet off-loading method of the System Architecture Evolution (SAE) of the second embodiment is the same as that of the first embodiment. Refer to FIG. 2 for a schematic diagram of a system framework of the present invention, and FIG. 3 for a schematic diagram of a packet off-loading route simultaneously. As shown in FIGS. 1 & 3, a base station (eNode B) 40 sends out packets directly to a first multi-service-packet-control unit 14, then the first multi-service-packet-control unit 14 will off-load the packets onto the Internet/Intranet 20, and then the packets off-loaded to the Internet/Intranet 20 will be converged to a second multi-service-packet-control unit 16 via a convergent route 72, and the packets will be transmitted to a Serving Gateway (S-GW) 54 via the second multi-service-packet-control unit 16, and then the Serving Gateway (S-GW) 54 will perform packet exchange with a Packet Data Network Gateway (P-GW) 56; or, alternatively, the packets can be transmitted to a destination server 22 via a non-convergent route 74. Wherein, the convergent route 72 is a Virtual Private Network Tunnel, so as to ensure the security and integrity of the packets transmitted through the convergent route 72. And for the packets transmitted through the non-convergent route 74, they must first undergo network address conversion as performed by the first multi-service-packet-control unit 14, such that on receiving the packets, the destination server 22 is able to respond to the first multi-service-packet-control unit 14 based on the converted address.

As mentioned above, before performing packet off-loading by the Universal Mobile Telecommunications System (UMTS) 30 and the System Architecture Evolution (SAE) 70, it must be assured that the control-plane packet and the user-plane packets are separated. The control-plane is used to transmit the instructions of resource allocation, connection setup, and synchronous message (such as IEEE 1588v2, Synchronous Ethernet, etc.), therefore, high-stability and low-latency routes have to be used. In the case of non-convergent route 74, the packets separation is realized by the first multi-service-packet-control unit 14 as based on the formats of control-plane packet and user-plane packet, hereby ensuring that the user's instructions can be transmitted and indeed reach the Core Network. In the following, the formats of control-plane packet and user-plane packet will be described in detail.

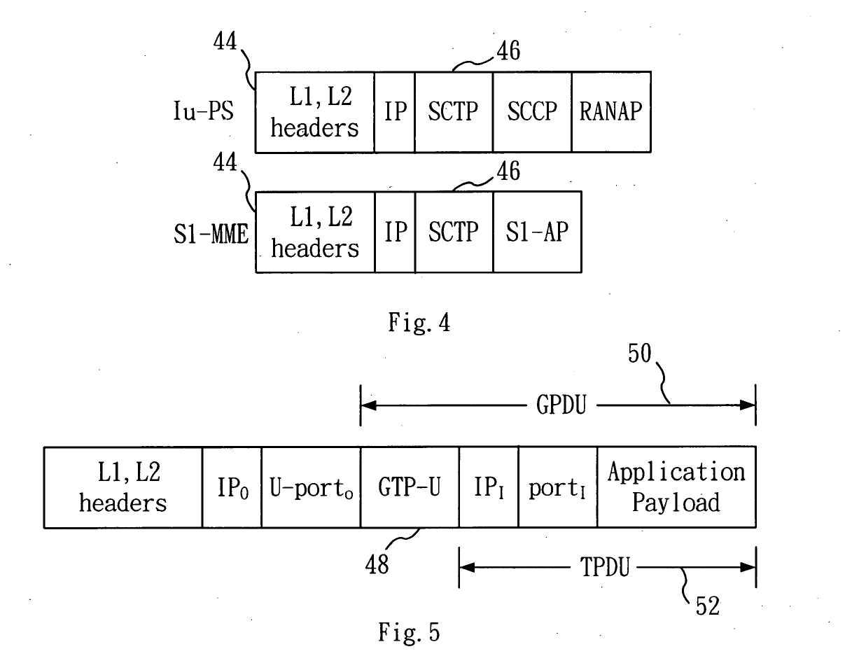

Refer to FIG. 4 for a schematic diagram of a format of a control-plane packet according to an embodiment of the present invention. As shown in FIG. 4, the format of a control-plane packet 44 transmitted to a packet-switching-interface-protocol interface (Iu-PS) 28 and the format of a control-plane packet 44 transmitted to a control plane (S1-MME) 58 are each in compliance with a Stream Control Transmission Protocol (SCTP) 46. Therefore, the control-plane packet is determined as based on SCTP 46, and the control-plane packet is transmitted according to the Stream Control Transmission Protocol/Internet Protocol (SCTP/IP).

Refer to FIG. 5 for a schematic diagram of a format of a user-plane packet according to an embodiment of the present invention. As shown in FIG. 5, the packet transmission through a packet-switching-interface-protocol interface (Iu-PS) 28 and a user plane (S1-U) 42 is performed in a form of GPRS Tunneling Protocol-User Plane (GTP-U) tunnel, such that each tunnel can only transmit the third layer traffic flow of a corresponding User Entity (UE). The packet having a Tunnel Protocol Data Unit (TPDU) 52 is transmitted by a User Entity (UE), and upon reaching a packet-switching-interface-protocol-interface (Iu-PS) 28 or a user plane (S1-U) 42, the outer layer of the packet will be attached a GTP-U header 48 to become a GPRS Protocol Data Unit (GPDU) 50, and the header is provided with a Tunnel Endpoint Identifier (TEID) for identifying a corresponding transmission tunnel, and then the packet is transmitted to the next terminal in compliance with a User Data Protocol/Internet Protocol (UDP/IP).

Furthermore, the assurance of the Quality of Service (QoS) of packet transmission can be realized in an application-based way or a GTP-U Tunnel-Based way respectively, and the functions and operations of which will be described in detail as follows.

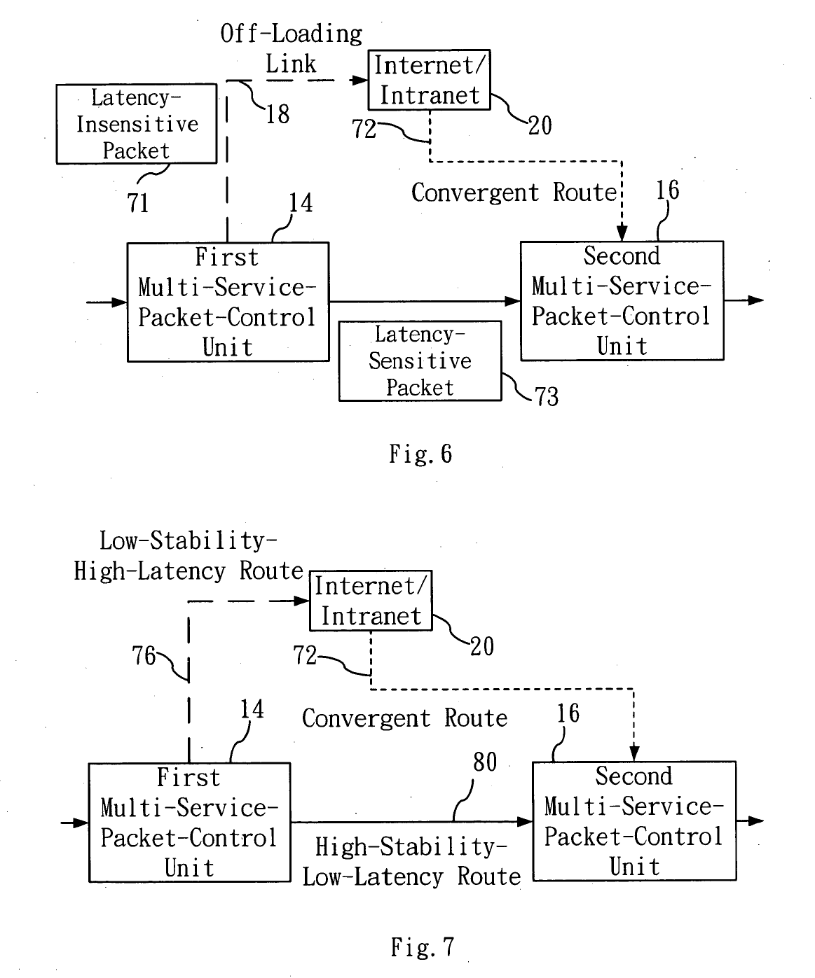

Refer to FIG. 6 for a schematic diagram of convergent route transmission in realizing Quality of Service in an application-based way. As shown in FIG. 6, in the application-based way, the header of a packet is used to determine the classification of service in distinguishing the packet is a Latency-Sensitive Packet 73 or a Latency-Insensitive Packet 71, and then adjusting their priority sequence based on their respective characteristics. By way of example, the Voice over IP (VoIP) of a Latency-Sensitive Packet 73 is transmitted in compliance with a Real Time Protocol (RTP). As such, the Latency-Sensitive Packet 73 can be identified through determining if a User Datagram Protocol (UDP) packet is contained in a Tunnel Protocol Data Unit (TPDU) 52 and if it does contain a Real Time Protocol (RTP) header; and the Latency-Insensitive Packet 71 can be identified through determining if Tunnel Protocol Data Unit (TPDU) 52 does contain a Transmission Control Protocol (TCP) packet. As such, the Latency-Sensitive Packet 73 is transmitted through the first multi-service-packet-control unit 14 directly to a second multi-service-packet-control unit 16 to proceed with packet transmission via a high-stability-low-latency route, such as T1/E1 dedicated line, Carrier Ethernet, MPLS (Multi-Protocol Labeling Switching) etc.; while the Latency-Insensitive Packet 71 is off-loaded onto an Internet/Intranet 20 through the first multi-service-packet-control unit 14, then the packet is converged to the second multi-service-packet-control unit 16 via a convergent route 72 to proceed with packet transmission.

Finally, refer to FIG. 7 for a schematic diagram of convergent route transmission for realizing Quality of Service in a GTP-U Tunnel-Based way. As shown in FIG. 7, in the GTP-U Tunnel-Based way, the route between a first multi-service-packet-control unit 14 and an Internet/Intranet 20 is a kind of low-stability-high-latency route 76, such as xDSL, FTTX, PON(Passive Optical Network), WiFi (Wireless Fidelity) etc.; and the route between the first multi-service-packet-control unit 14 and the second multi-service-packet-control unit 16 is a kind of high-stability-low-latency route 80. The first multi-service-packet-control unit 14 will guide the packets having High Tunnel Priority Identity to a high-stability-low-latency route 80 of fast transmission speed based on a Quality of Service (QoS) message contained in a Tunnel Endpoint Identifier (TEID) in a GTP-U header 48 or a network element setup message determining the QoS, and transmit the packets directly to the second multi-service-packet-control unit 16 to proceed with packet transmission; or, alternatively, the first multi-service-packet-control unit 14 will guide the packets having Low Tunnel Priority Identity to a low-stability-high-latency route 76 and off-load them onto an Internet/Intranet 20, and then converge the packets to the second multi-service-packet-control unit 16 via a convergent route 72 to proceed with packet transmission. In addition, the load of packet flow on the convergent route 72 and non-convergent route 74 can be balanced through a load balance mechanism by off-loading packets evenly onto the convergent route 72 and the non-convergent route 74, thus avoiding uneven load on transmission links.

Summing up the above, in the present invention, a first multi-service-packet-control unit 14 and a second multi-service-packet-control unit 16 are provided in a Universal Mobile Telecommunications System (UMTS) 30 and a System Architecture Evolution (SAE) 70 respectively, thus achieving off-loading the packet transmission load through utilizing an off-loading link 18, a convergent route 72, and a non-convergent route 74, hereby reducing transmission cost while keeping the quality of service at the same time.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A telecommunication network broadband off-loading system, comprising:
at least a base station, used to send out at least a packet;
at least a radio network controller, connected to said base station, and is used to receive and recombine said packet sent out by said base station;
a first multi-service-packet-control unit, connected to said radio network controller, and is used to offset and off-load said packet onto an off-loading link, and transmit said packet to an Internet/Intranet via said off-loading link; and
a second multi-service-packet-control unit, connected to said Internet/Intranet, and is used to receive said packet transmitted to said Internet/Intranet, and converge said packet to a serving General Packet Radio Service (GPRS) Support Node (SGSN).

2. The telecommunication network broadband off-loading system as claimed in claim 1, further comprising:
a destination server, connected to said Internet/Intranet, and said packet can be transmitted directly to said destination server via said Internet/Intranet.

3. The telecommunication network broadband off-loading system as claimed in claim 1, further comprising:
a Gateway General Packet Radio Service (GPRS) Support Node (GGSN), connected to said Serving General Packet Radio Service (GPRS) Support Node (SGSN) to proceed with exchange and transmission of said packet.

4. The telecommunication network broadband off-loading system as claimed in claim 1, further comprising:
a packet-switching-interface-protocol interface (Iu-PS), said first multi-service-packet-control unit and said second multi-service-packet-control unit are connected to each other through said packet-switching-interface-protocol interface (Iu-PS).

5. The telecommunication network broadband off-loading system as claimed in claim 1, wherein
said first multi-service-packet-control unit can be integrated into said radio network controller, and said second multi-service-packet-control unit can be integrated into said Serving General Packet Radio Service (GPRS) Support Node (SGSN).

6. The telecommunication network broadband off-loading system as claimed in claim 1, wherein
said first multi-service-packet-control unit and said second multi-service-packet-control unit are each provided with: a caching mechanism for reducing a bandwidth utilized and shortening the response latency of said destination server;
a filtering mechanism for detecting viruses contained in said packet; and a compression mechanism for compressing said packet, hereby raising transmission efficiency of said packet.

7. A telecommunication network broadband off-loading system, comprising:
at least a base station, used to send out at least a packet;
a first multi-service-packet-control unit, connected to said base station, and is used to receive and recombine said packet sent out from said base station, and off-load said packet onto an off-loading link, and transmit said packet to an Internet/Intranet via said off-loading link; and
a second multi-service-packet-control unit, connected to said Internet/Intranet, and is used to receive said packet transmitted to said Internet/Intranet, and converge said packet to a Serving Gateway (S-GW).

8. The telecommunication network broadband off-loading system as claimed in claim 7, further comprising:
a destination server, connected to said Internet/Intranet, and said packet can be transmitted directly to said destination server via said Internet/Intranet.

9. The telecommunication network broadband off-loading system as claimed in claim 7, further comprising:
a Packet Data Network Gateway (P-GW), connected to said Serving Gateway (S-GW) to proceed with exchange and transmission of said packet.

10. The telecommunication network broadband off-loading system as claimed in claim 7, further comprising:
a user plane (S1-U), said first multi-service-packet-control unit and said second multi-service-packet-control unit are connected to each other via said user plane (S1-U).

11. The telecommunication network broadband off-loading system as claimed in claim 7, further comprising:
a Mobility Management Entity (MME), connected to said Serving Gateway (S-GW) to proceed with exchange and transmission of said packet.

12. The telecommunication network broadband off-loading system as claimed in claim 11, further comprising:
a control plane (S1-MME), and said first multi-service-packet-control unit and said Mobility Management Entity (MME) are connected to each other via said control plane (S1-MME).

13. The telecommunication network broadband off-loading system as claimed in claim 7, wherein
said first multi-service-packet-control unit can be integrated into said base station, and said second multi-service-packet-control unit can be integrated into said Serving Gateway (S-GW).

14. The telecommunication network broadband off-loading system as claimed in claim 7, wherein
said first multi-service-packet-control unit and said second multi-service-packet-control unit are each provided with: a caching mechanism for reducing said bandwidth utilized and shortening response latency of said destination server; a filtering mechanism for detecting said viruses contained in said packet; and a compression mechanism for compressing said packet, hereby raising transmission efficiency of said packet.

15. A telecommunication network broadband off-loading method, comprising the following steps:
transmitting a packet to a first multi-service-packet-control unit, and off-loading said packet to an Internet/Intranet by utilizing said first multi-service-packet-control unit;
converging said packet off-loaded to said Internet/Intranet to a second multi-service-packet-control unit via a convergent route; and
transmitting said packet by said second multi-service-packet-control unit to proceed with exchange of said packet.

16. The telecommunication network broadband off-loading method as claimed in claim 15, wherein
said convergent route is a Virtual Private Network Tunnel, and for its upper layer transmission protocol a reliable Transmission Control Protocol (TCP) is utilized, for ensuring security and integrity of packet transmission.

17. The telecommunication network broadband off-loading method as claimed in claim 15, wherein
said packet can be guided into a non-convergent route via said Internet/Intranet for directly transmitting it to a destination server.

18. The telecommunication network broadband off-loading method as claimed in claim 15, wherein
a network address of said packet transmitted through said non-convergent route is converted by said first multi-service-packet-control unit, such that on receiving said packet, said destination server is able to respond to said first multi-service-packet-control unit based on said network address.

19. The telecommunication network broadband off-loading method as claimed in claim 15, wherein
said convergent route is used to realize Quality of Service in an Application-Based Way and a GTP-U Tunnel-Based Way.

20. The telecommunication network broadband off-loading method as claimed in claim 19, wherein
said Application-Based Way is used to classify said packet into a Latency-Insensitive Packet or a Latency-Sensitive Packet.

21. The telecommunication network broadband off-loading method as claimed in claim 20, wherein
said Latency-Sensitive Packet transmitted directly from said first multi-service-packet-control unit to said second multi-service-packet-control unit via a high-stability-low-latency route to proceed with transmission of said packet.

22. The telecommunication network broadband off-loading method as claimed in claim 20, wherein
said Latency-Insensitive Packet is off-loaded onto said Internet/Intranet through said first multi-service-packet-control unit, and then is transmitted via said non-convergent route and said convergent route.

23. The telecommunication network broadband off-loading method as claimed in claim 19, wherein
said GTP-U Tunnel-Based Way is used to classify a route between said first multi-service-packet-control unit and said Internet/Intranet as a low-stability-high-latency route, and said route between said first multi-service-packet-control unit and said second multi-service-packet-control unit as a high-stability-low-latency route.

24. The telecommunication network broadband off-loading method as claimed in claim 23, wherein
said packet can be guided through said high-stability-low-latency route to proceed with packet transmission, or said packet can be off-loaded to said Internet/Intranet through said low-stability-high-latency route, and then is transmitted through said non-convergent route or said convergent route.

25. The telecommunication network broadband off-loading method as claimed in claim 15, further comprising:
a load balance mechanism, used to evenly off-load said packets onto said convergent route and said non-convergent route in achieving balanced load of packet transmission.

26. The telecommunication network broadband off-loading method as claimed in claim 15, wherein
in said step of transmitting said packet, said packet is transmitted from a base station to said first multi-service-packet-control unit via a radio network controller, or said packet is transmitted directly from said base station to said first multi-service-packet-control unit.
